(19) United States
(12) Patent Application Publication
(10) Pub. No.: US 2021/0101129 A1
(43) Pub. Date: Apr. 8, 2021

(54) IMMOBILIZED MEDIA DEVICE WITH A THERMOPLASTIC POLYMER BINDER SYSTEM

(71) Applicant: Arkema Inc., King of Prussia, PA (US)

(72) Inventors: Roderick REBER, III, Maple Glen, PA (US); Sean M. STABLER, Bloomsburg, PA (US); Denis Kato DE ALMEIDA, Philadelphia, PA (US); Azaz A. VAHORA, Eagleville, PA (US); Florence MEHLMANN, Berwyn, PA (US)

(21) Appl. No.: 17/044,872

(22) PCT Filed: Apr. 8, 2019
(86) PCT No.: PCT/US2019/026269

§ 371 Date: Oct. 2, 2020

Related U.S. Application Data
(60) Provisional application No. 62/654,826, filed on Apr. 9, 2018.

(51) Int. Cl. B01J 20/26; B01J 20/20; B01J 20/18; B01J 20/28; B01J 20/30; B01D 39/20; C02F 1/00; C02F 1/28

(52) U.S. Cl. CPC B01J 20/262; B01J 20/20; B01J 20/18; B01J 20/261; B01J 20/2803; B01J 20/28042; B01D 2239/1241; B01J 20/3042; B01D 39/2062; C02F 1/001; C02F 1/283; B01D 2239/0407; B01D 2239/086; B01J 20/28004

(57) ABSTRACT

The present disclosure is directed to an immobilized media device and methods for making an immobilized media device. The present disclosure is also directed to methods for the separation of components of a media comprising filtering the media through an immobilized media device.

### FIELD

The present disclosure is related to a media device and uses of a media binder.

### BACKGROUND

Composite porous solid articles, such as porous separation articles and carbon block filtration articles, are known in the art. These articles are produced using mixtures of thermoplastic binders and active particles or fibrous materials such as activated carbon powder. The articles preferably are formed under conditions effective to permit the thermoplastic binder to connect the active particles or fibrous materials in discrete spots, rather than as a coating, forming an interconnected web. This arrangement permits the active powdery or fibrous materials to be in direct contact with, and to interact with, a fluid or gas. The resulting composite solid article is porous, thereby permitting the fluid or gas to penetrate into and pass through the article. Such articles are especially useful in water purification, purification of organic waste streams, in biological separations, and gas streams for purification and/or storage.

U.S. Pat. No. 6,395,190 describes carbon filters and a method for making them having a 15 to 25 weight percent of a thermoplastic binder, where the average particle size is from 5 to 25 microns; and having activated carbon particles where the majority of the particles are in the 200-325 mesh range (44-74 microns), with the rest of the activated carbon is less than 325 mesh.

Fluoropolymer filtration membranes are well known, as described in U.S. patents such as U.S. Pat. Nos. 6,013,688 and 6,110,309. Fluoropolymers, such as polyvinylidene fluoride (PVDF) are very chemically and biologically inert and have outstanding mechanical properties. They are resistant to oxidizing environments, such as chlorine and ozone, which are widely used in the sterilization of water. PVDF membranes are also highly resistant to attack by most mineral and organic acids, aliphatic and aromatic hydrocarbons, alcohols, and halogenated solvents. Fluoropolymers in general, and especially PVDF, is resistant to degradation due to sterilization techniques, for example, steam, chemicals, UV radiation, irradiation, and ozone.

U.S. Pat. No. 3,864,124 describes the use of polytetrafluoroethylene (PTFE) to immobilize a non-fiberizing material.

U.S. Pat. Nos. 5,019,311, 5,147,722 and 5,331,037 describe an extrusion process to produce a porous structure containing interactive particles bound together by a polymer binder. The porous structure is described as a “continuous web matrix” or “forced point bonds.” The solid composite article is useful as a high performance water filter, such as in a carbon block filter. Thermoplastic binders listed for use in the process include polyvinyl fluoride as the only fluoropolymer, with examples of polyethylene and polyamide 11. Polyvinyl fluoride is difficult to process, as it is not thermoplastic.

U.S. 2010/0304270 describes the use of an aqueous composition containing a high molecular weight aqueous fluoropolymer binder and a powdery material (such as carbon) to produce a porous solid material in which the particles are bound together only at specific discrete points to produce interconnectivity. The particles are bound together in a continuous web, while leaving the majority of each particle exposed to fluids passing over them. The binder level used is 0.5 to 25%, preferably 0.5-15% and most preferably from 1-10%.

### SUMMARY

The present disclosure provides that the retention of small particles is possible by using a small particle size binder in conjunction with a large particle binder. In certain embodiments, the present disclosure provides use of two different typically immiscible polymers as binders, finding that the incompatibility surprisingly does not result in a lower strength. The present disclosure allows for operations that are configured to use ultra-high molecular weight polyethylene or other large particle size binders to easily reduce the fine particle release from blocks without a major process change.

Embodiments of the present disclosure are related to an immobilized media device, comprising adsorbent; a small particle size binder; and a large particle size binder. Embodiments of the present disclosure are also directed to a process for preparing an immobilized media binder comprising: combining adsorbent, such as activated carbon, and a small particle size binder; and adding a large particle size binder. The present disclosure further provides a method for the separation of components of a fluid comprising filtering the fluid through an immobilized media binder.

Within this specification embodiments have been described in a way which enables a clear and concise specification to be written, but it is intended and will be appreciated that embodiments may be variously combined or separated without parting from the invention. For example, it will be appreciated that all preferred features described herein are applicable to all aspects of the invention described herein.

Aspects of the invention include:
Aspect 1. An immobilized media device, made of:
a. at least one adsorbent;
b. from about 0.5 to about 15 weight percent a small particle size binder; and
c. from about 8 to about 50 weight percent a large particle size binder.

2. The device of aspect 1, where the small particle size binder and large particle size binder are immiscible.

3. The device of aspect 1, where the small particle size binder and large particle size binder are miscible or are the same type of polymer.

4. The device of the previous aspects 1 or 3, where said small particle size binder and large particle size binder are made of different monomer repeat units.

5. The device of any of the previous aspects 1 to 4, where the adsorbent is activated carbon or molecular sieves.

6. The device of any of the previous aspects 1 to 5, where the small particle size binder are thermoplastic polymer(s), where the large particle size binder are thermoplastic polymer(s), or where both the large and small particles are thermoplastic polymer.

7. The device of any of the previous aspect 6, where the thermoplastic polymer of the small particle binder is selected from the groups consisting of a fluoropolymer, polyethylene, polypropylene, ethyl-vinyl acetate, polyamide, polyvinylidene fluoride, polyalkyl (meth)acrylate, polyether ether ketone, polyetherketoneketone; and polyolefin.

8. The device of any of the previous aspect 6, where the thermoplastic polymer of the large particle binder is selected from the groups consisting of a fluoropolymer, polyethylene, polypropylene, ethyl-vinyl acetate, polyamide, polyvinylidene fluoride, polyalkyl (meth)acrylate, polyether ether ketone, polyetherketoneketone; and polyolefin.

9. The device of aspect 8, wherein the polyolefin is a polyalkylene, or a polyethylene, the polyethylene may be a high molecular weight and/or ultra-high molecular weight and/or low density polyethylene.

10. The device according to any of the aspects 1-9, where the small particle size binder and the large particle size binder form a bimodal particle size distribution system.

11. The device according to any of aspects 1-10, where the small particle size binder has an average particle size of between about 0.01 micrometers to less than 25 micrometers, and where the large particle size binder has an average particle size of greater than 25 micrometers to about 500 micrometers.

12. A process for preparing an immobilized media device having the steps of:

a. blending adsorbent and a small particle size binder; and

b. adding a large particle size binder.

13. The process according to aspect 12, wherein the adsorbent is activated carbon or other adsorbent having a small particle size additive of less than 20 micron.

14. A method for the separation of components from a fluid containing the components comprising filtering the fluid through an immobilized media device according to any of aspects 1-11.

15. The method according to aspect 14, where the fluid comprises a liquid or a gas.

16. The method according to any one of aspects 14 or 15, where the fluid is selected from the group consisting of water, brine, oil, diesel fuel, biodiesel fuel, a pharmaceutical or bio-pharmaceutical fluid, aliphatic solvents, strong acids, hot (>80° C.) chemical compounds, hydrocarbons, hydrofluoric acid, ethanol, methanol, ketones, amines, strong bases, “fuming” acids, strong oxidants, aromatics, ethers, ketones, glycols, halogens, esters, aldehydes, and amines, compounds of benzene, compounds of chlorine, compounds of bromine, toluene, butyl ether, acetone, ethylene glycol, ethylene dichloride, ethyl acetate, formaldehyde, butyl amines, exhaust gases, automotive exhaust, groundwater, methane, naptha, butane, kerosene, and other hydrocarbon chemicals.

17. The method according to any one of aspects 14-16, where the components are selected from the group consisting of particulates; biological and pharmaceutical active ingredients; organic compounds; acids, bases, hydrofluoric acid; cations of hydrogen, aluminum, calcium, lithium, sodium, and potassium; anions of nitrate, cyanide and chlorine; metals, chromium, zinc, lead, mercury, copper, silver, gold, platinum, iron; salts, sodium chloride, potassium chloride, sodium sulfate.

18. The immobilized media device of aspect 1 may be in the form of a monolith, an annulus or a solid article.

### BRIEF DESCRIPTION OF THE FIGURES

FIG. 1 depicts filtrate from a block containing 30 wt % GUR2122 UHMWPE.

FIG. 2 depicts filtrate from a block containing 30 wt % GUR2122 UHMWPE and 3 wt % Kyblock® FG-42 resin.

FIG. 3 depicts filtrate from a block containing 30 wt % GUR2122 UHMWPE and 5 wt % Kyblock® FG-42 resin.

FIG. 4 shows the absorbance of the filtrate versus the volume of water filtered of Example 2 (samples 10, 11 and 12).

FIG. 5 depicts filtrate from a block containing 12% LDPE FN 510 and 16% Lead surrogate

FIG. 6 depicts filtrate from a block containing 9% LDPE FN 510, Kyblock® 3% FG 42 and 16% Lead surrogate.

### DETAILED DESCRIPTION

Embodiments of the present disclosure include an immobilized media device that provides improved particle retention. This can be quantified by reduced turbidity or improved light transmission of filtered water.

Various examples and embodiments of the inventive subject matter disclosed here are possible and will be apparent to a person of ordinary skill in the art, given the benefit of this disclosure. In this disclosure reference to “some embodiments,” “certain embodiments,” “certain exemplary embodiments” and similar phrases each means that those embodiments are non-limiting examples of the inventive subject matter, and there may be alternative embodiments which are not excluded.

The articles “a,” “an,” and “the” are used herein to refer to one or more than one (i.e., to at least one) of the grammatical object of the article. By way of example, “an element” means one element or more than one element.

As used herein, the term “about” means±10% of the noted value. By way of example only, a composition comprising “about 30 wt. %” of a compound could include from 27 wt. % of the compound up to and including 33 wt. % of the compound.

The word “comprising” is used in a manner consistent with its open-ended meaning, that is, to mean that a given product or process can optionally also have additional features or elements beyond those expressly described. It is understood that wherever embodiments are described with the language “comprising,” otherwise analogous embodiments described in terms of “consisting of” and/or “consisting essentially of” are also contemplated and within the scope of this disclosure.

### Immobilized Media Device

In certain embodiments, the present disclosure provides a device comprising a small particle size binder and a large particle size binder.

The present disclosure provides an immobilized media device. In certain embodiments, the immobilized media device comprises media, such as an adsorbent(s); a small particle size binder; and a large particle size binder. In certain embodiments, the immobilized media device comprises activated carbon; a small particle size binder; and a large particle size binder.

In certain embodiments, the immobilized media can be one or more types of interactive particles or fibers combined with a polymer binder. The interactive particles or fibers are not merely fillers or pigments, but are those which have a physical, electrical, or chemical interaction when they come into proximity or contact with dissolved or suspended materials in a fluid (liquid or gas) composition. They can also be materials useful in battery electrodes for conductance of electrons.

Depending on the type of activity of the interactive particles, the particles may separate the dissolved or suspended materials by chemical reaction, physical entrapment, physical attachment, electrical (charge or ionic) attraction, or similar means. Examples of interactions include, but are not limited to: physical entrapment of compounds from the fluid, such as in activated carbon, nano clays, or zeolite particles; ion exchange resins; catalysts; electromagnetic particles; acid or basic particles for neutralization; carbonaceous materials for a negative electrode; a Li plus transition metal oxide, sulfide or hydroxide for a positive electrode; etc.

In certain embodiments, examples of interactive particles of fibers include, but are not limited to: metallic particles of 410, 304, and 316 stainless steel, copper, aluminum and nickel powders, ferromagnetic materials, activated alumina, activated carbon, carbon nanotubes, silica gel, acrylic powders and fibers, cellulose fibers, glass beads, various abrasives, common minerals such as silica, wood chips, ion-exchange resins, molecular sieves, ceramics, zeolites, diatomaceous earth, polyester particles and fibers, and particles of engineering resins such as polycarbonate. The interactive particles could also be enzymes, antibodies, and proteins immobilized on a support substrate.

Small Particle Size Binder

In certain embodiments, the immobilized media device comprises from above about 0.5 to about 15 weight percent of a small particle size binder. In certain embodiments, the immobilized media device comprises above about 0.5 to about 5 weight percent of a small particle size binder. In certain embodiments, the immobilized media device comprises above about 0.5 to about 10 weight percent a small particle size binder. In certain embodiments, the immobilized media device comprises about 5 to about 10 weight percent a small particle size binder. In certain embodiments, the immobilized media device comprises about 5 to about 15 weight percent a small particle size binder.

In certain embodiments, the immobilized media device comprises a small particle size binder in an amount of about 0.1 weight percent, about 0.5 weight percent, about 1 weight percent, about 2 weight percent, about 3 weight percent, about 4 weight percent, about 5 weight percent, about 6 weight percent, about 7 weight percent, about 8 weight percent, about 9 weight percent, about 10 weight percent, about 11 weight percent, about 12 weight percent, about 13 weight percent, about 14 weight percent, about 15 weight percent, or any ranges between the specified values.

In certain embodiments, the small particle size binder has an average particle size of about 0.01 micrometers to less than 25 micrometers. In certain embodiments, the small particle size binder has an average particle size of about 0.01 micrometers to less than 20 micrometers. In certain embodiments, preferably less than 19 micrometers, more preferably less than 18 micrometers, the small particle size binder has an average particle size of about 1 micrometer to about 20 micrometers, and more preferably from 1 to 18 micrometers, more preferably from 1 to 15 micrometers.

In certain embodiments, the small particle size binder has an average particle size of about 0.01 micrometers, about 0.05 micrometers, about 0.1 micrometers, about 0.5 micrometers, about 1 micrometers, about 2 micrometers, about 3 micrometers, about 4 micrometers, about 5 micrometers, about 6 micrometers, about 7 micrometers, about 8 micrometers, about 9 micrometers, about 10 micrometers, about 11 micrometers, about 12 micrometers, about 13 micrometers, about 14 micrometers, about 15 micrometers, about 16 micrometers, about 17 micrometers, about 18 micrometers, 19 micrometers, 20 micrometers, or any ranges between the specified values.

In certain embodiments, the small particle size binder comprises a thermoplastic polymer. In certain embodiments, the thermoplastic polymer can be a fluoropolymer, polyethylene, polypropylene, ethyl-vinyl acetate, polyamide, polyvinylidene fluoride, polyalkyl (meth)acrylate, polyether ether ketone, or polyetherketoneketone. In certain embodiments, the thermoplastic polymer can be a fluoropolymer. In certain embodiments, the fluoropolymer can be a polyvinylidene fluoride polymer.

Large Particle Size Binder

In certain embodiments, the immobilized media device comprises from about 3 to 50 weight percent of large particles, preferably 5 to 30 wt %, more preferably 8 to 25 wt %. In certain embodiments, the total binder comprises about 75 to 99.5 wt % or from 85 to about 98 weight percent or 90 to 98 wt % a large particle size binder. In certain embodiments, the binder comprises about 88 to about 96 or from 92 to 96 weight percent a large particle size binder.

In certain embodiments, the binder comprises a large particle size binder in an amount of about 75 weight percent, 85 weight percent, about 86 weight percent, about 87 weight percent, about 88 weight percent, about 89 weight percent, about 90 weight percent, about 91 weight percent, about 92 weight percent, about 93 weight percent, about 94 weight percent, about 95 weight percent, about 96 weight percent, about 97 weight percent, about 98 weight percent, about 99 weight percent, about 99.5 weight percent, or any ranges between the specified values.

In certain embodiments, the large particle size binder has an average particle size of greater than 20 micrometers to about 500 micrometers, preferably of greater than 25 micrometers to about 500 micrometers. In certain embodiments, the large particle size binder has an average particle size of about 100 micrometers to about 300 micrometers.

In certain embodiments, the large particle size binder has an average particle size of greater than 20 micrometers, greater than 25 micrometers, greater than 30 micrometers, greater than 40 micrometers, greater than 50 micrometers, greater than 60 micrometers, greater than 70 micrometers, greater than 80 micrometers, greater than 90 micrometers, greater than 100 micrometers, greater than 110 micrometers, greater than 120 micrometers, greater than 130 micrometers, greater than 140 micrometers, greater than 150 micrometers, greater than 175 micrometers, greater than 200 micrometers, greater than 225 micrometers, greater than 250 micrometers, greater than 275 micrometers, greater than 300 micrometers, greater than 325 micrometers, greater than 350 micrometers, greater than 375 micrometers, greater than 400 micrometers, greater than 425 micrometers, greater than 450 micrometers, greater than 475 micrometers, greater than 500 micrometers, or any ranges between the specified values.

In certain embodiments, the small particle size binder can have an average particle size of less than 20 micrometers. In certain embodiments, the large particle size binder can have an average particle size of greater than 20 micrometers.

In certain embodiments, the large particle size binder comprises a thermoplastic polymer. In certain embodiments, the large particle size binder can be a fluoropolymer, polyethylene, propylene, ethyl-vinyl acetate, polyamide, polyvinylidene fluoride, polyalkyl (meth)acrylate, polyether ether ketone, or polyetherketoneketone. In certain embodiments, the thermoplastic polymer comprises a polyolefin. In certain embodiments, the polyolefin comprises a polyalkylene. In certain embodiments, the polyalkylene comprises a polyethylene. In certain embodiments, the polyethylene comprises high and/or ultra-high molecular weight polyethylene.

In certain embodiments, the small particle size binder and large particle size binder are immiscible. An immiscible binder composition containing two or more polymers exhibits more than one distinct glass transition temperature when blended. In certain embodiments, the small particle size binder and large particle size binder are miscible.

In certain embodiments, the immobilized media device can be an annulus or a solid article.

In certain embodiments, the immobilized media device can be formed into an immobilized media monolith.

### Polymers Binders

In certain embodiments, the larger particle size is at least 1.85 times the smaller particle size.

In certain embodiments, a small particle size binder or a large particle size binder can be a fluoropolymer, polyethylene, ethyl-vinyl acetate, polyamide, polyvinylidene fluoride, polyalkyl (meth)acrylate, polyether ether ketone, or polyetherketoneketone. In some embodiments the small particle size binder and the large particle size binder are the same composition. In some embodiments the small particle size binder and the large particle size binder are different compositions.

The term fluoropolymer can denotes any polymer that has in its chain at least one monomer chosen from compounds containing a vinyl group capable of opening in order to be polymerized and that contains, directly attached to this vinyl group, at least one fluorine atom, at least one fluoroalkyl group, or at least one fluoroalkoxy group.

Examples of fluoromonomers include, but are not limited to vinyl fluoride; vinylidene fluoride (VDF); trifluoroethylene (VF3); chlorotrifluoroethylene (CTFE); 1,2-difluoroethylene; tetrafluoroethylene (TFE); hexafluoropropylene (HFP); perfluoro(alkyl vinyl) ethers, such as perfluoro(methyl vinyl) ether (PMVE), perfluoro(ethyl vinyl) ether (PEVE) and perfluoro(propyl vinyl) ether (PPVE); perfluoro(1,3-dioxole); perfluoro(2,2-dimethyl-1,3-dioxole) (PDD).

In certain embodiments, fluoropolymers include homopolymers and copolymers of polyvinylidene fluoride (PVDF), ethylene tetrafluoroethylene (ETFE), terpolymers of ethylene with tetrafluoroethylene and hexafluoropropylene (EFEP), terpolymers of tetrafluoroethylene-hexafluoropropylene-vinyl fluoride (THV), copolymers of vinyl fluoride; and blends of PVDF with polymethyl methacrylate (PMMA) polymers and copolymers, or thermoplastic polyurethanes. PMMA can be present at up to 49 weight percent based on the weight of the PVDF, and preferably from 5 to 25 weight percent. PMMA is melt-miscible with PVDF, and can be used to add hydrophilicity to the binder. A more hydrophilic composition provides for an increased water flow—resulting in less of a pressure drop across the composite article.

The PVDF may be a homopolymer, a copolymer, a terpolymer or a blend of a PVDF homopolymer or copolymer with one or more other polymers that are compatible with the PVDF (co)polymer. PVDF copolymers and terpolymers of the present disclosure are those in which vinylidene fluoride units comprise greater than 40 percent of the total weight of all the monomer units in the polymer, such as greater than 70 percent of the total weight of the units.

Copolymers, terpolymers and higher polymers of vinylidene fluoride may be made by reacting vinylidene fluoride with one or more monomers selected from the group consisting of vinyl fluoride, trifluoroethene, tetrafluoroethene, one or more of partly or fully fluorinated alpha-olefins such as 3,3,3-trifluoro-1-propene, 1,2,3,3,3-pentafluoropropene, 3,3,3,4,4-pentafluoro-1-butene, and hexafluoropropene, the partly fluorinated olefin hexafluoroisobutylene, perfluorinated vinyl ethers, such as perfluoromethyl vinyl ether, perfluoroethyl vinyl ether, perfluoro-n-propyl vinyl ether, and perfluoro-2-propoxypropyl vinyl ether, fluorinated dioxoles, such as perfluoro(1,3-dioxole) and perfluoro(2,2-dimethyl-1,3-dioxole), allylic, partly fluorinated allylic, or fluorinated allylic monomers, such as 2-hydroxyethyl allyl ether or 3-allyloxypropanediol, and ethene or propene.

In certain embodiments, up to 30%, up to 25%, or up to 15% by weight of hexafluoropropene (HFP) units and 70%, 75%, or 85% by weight or more of VDF units can be present in the vinylidene fluoride polymer.

In certain embodiments, PVDF can be a representative small particle size binder.

The PVDF for use in the embodiments of the present disclosure can have a high molecular weight. In certain embodiments, high molecular weight can mean PVDF having a melt viscosity of greater than 1.0 kilopoise, such as greater than 5 Kp, from 15 to 50 Kp, and from 15 to 25 Kp, according to ASTM method D-3835 measured at 450° F. and 100 sec⁻¹. The high molecular weight polymer can provide for interconnectivity, as it has a higher viscosity and lower flow, so it does not entirely coat the interactive particles.

PVDF used in accordance with embodiments of the present disclosure can generally be prepared by means known in the art, using aqueous free-radical emulsion polymerization—although suspension, solution, and supercritical CO₂ polymerization processes may also be used.

In a general emulsion polymerization process, a reactor can be charged with deionized water, water-soluble surfactant capable of emulsifying the reactant mass during polymerization, and optional paraffin wax antifoulant. The mixture is stirred and deoxygenated. A predetermined amount of chain transfer agent, CTA, is then introduced into the reactor, the reactor temperature raised to the desired level and vinylidene fluoride (and possibly one or more comonomers) are fed into the reactor. Once the initial charge of vinylidene fluoride is introduced and the pressure in the reactor has reached the desired level, an initiator emulsion or solution is introduced to start the polymerization reaction. The temperature of the reaction can vary depending on the characteristics of the initiator used and one of skill in the art will know how to do so. Typically the temperature will be from about 30° to 150° C., such as from about 60° to 120° C. Once the desired amount of polymer has been reached in the reactor, the monomer feed can be stopped, but initiator feed is optionally continued to consume residual monomer. Residual gases (containing unreacted monomers) can be vented and the latex recovered from the reactor.

The surfactant used in the polymerization can be any surfactant known in the art to be useful in PVDF emulsion polymerization, including perfluorinated, partially fluorinated, and non-fluorinated surfactants. In a preferred embodiment, the PVDF emulsion of the present disclosure can be fluorosurfactant free, with no fluorosurfactants being used in any part of the polymerization. Non-fluorinated surfactants useful in the PVDF polymerization could be both ionic and non-ionic in nature including, but are not limited to, 3-allyloxy-2-hydroxy-1-propane sulfonic acid salt, polyvinylphosphonic acid, polyacrylic acids, polyvinyl sulfonic acid, and salts thereof, polyethylene glycol and/or polypropylene glycol and the block copolymers thereof, alkyl phosphonates and siloxane-based surfactants.

The PVDF polymerization can result in a latex generally having a solids level of 10 to 60 percent by weight, such as 10 to 50 percent, and having a latex weight average particle size of less than 500 nm, such as less than 400 nm and less than 300 nm. The weight average particle size can be at least 20 nm, such as at least 50 nm. Additional adhesion promoters can also be added to improve the binding characteristics and provide connectivity that is non-reversible. A minor amount of one or more other water-miscible solvents, such as ethylene glycol, may be mixed into the PVDF latex to improve freeze-thaw stability.

The PVDF latex can be used in certain embodiments as a latex binder, or it may be dried to a powder by means known in the art, such as, but not limited to, spray drying, freeze-drying, coagulating, and drum drying. Smaller size PVDF powder particles can be useful, as they result in a decreased distance (higher density) of interactive particles. In an article formed directly from the emulsion, the emulsion particle can interact and adhere to two or more particles at discrete points on those particles. In an extrusion process, the polymer resin particles can soften in the non-crystalline regions to adhere to the particles at discrete points, but do not melt to completely cover the particles.

In certain embodiments, polyvinylidene fluoride resins can include Kynar® PVDF powders. In certain embodiments, polyvinylidene fluoride resins can include, but are not limited to Kyblock® resins from Arkema Inc., especially Kyblock® resin, with an agglomerate particle size of 3-8 microns and a melt viscosity of 16.5-22-5 kpoise; Kyblock®resin, with a particle size of 3-6 microns and a melt viscosity of 16.5-22-5 kpoise, Kyblock®resin, with a particle size of 3-8 microns and a melt viscosity of 23.0-29.0 kpoise; Kyblock® resin, with a particle size of 3-8 microns and a melt viscosity of 44.5-54.5 kpoise; and Kyblock® resin, with a particle size of 3-8 microns and a melt viscosity of 35.0-39.0 kpoise. Kyblock® resin, with a particle size of 5-15 microns and a melt viscosity of 22.0-27.0 kpoise. The melt viscosities being measured by ASTM D3835 at 232° C. and 100 s⁻¹. The agglomerated particle size contains primary discrete particles in the range of 50 to 500, and preferably 100 to 300 nanometers. The agglomerate particles can, and preferably do break into the discrete primary particles during the process of forming the immobilized media. In a preferred embodiment, less than 10 weight percent of the polyvinylidene fluoride particles, preferably less than 5 weight percent, less than 2 weight percent and preferably less than 1 weight percent of the primary particles remain in agglomerated form in the final immobilized media.

In certain embodiments, copolymers of VDF and HFP can be used. These copolymers have a lower surface energy. It is noted that PVDF in general has a lower surface than other polymers such as polyolefins. Lower surface energy can lead to better wetting of the interactive particle, and a more uniform dispersion. This can result in an improvement in the integrity of the separation device over a polymer binder with a higher surface energy, and can result in the need for a lower level of binder. Additionally, PVDF/HFP copolymers can have a lower crystallinity and a lower glass transition temperature (Tg), and therefore can be processed at a lower temperature in a melt process.

In certain embodiment, the PVDF polymer can be a functional PVDF, such as functionalized/grafted fluoropolymers and maleic anhydride-grafted or polyacrylic acid grafted PVDF from Arkema. The functional PVDF can improve the binding to interactive particles or fibers, which can permit a lower level of PVDF loading in the formulation. This lower loading-excellent binding combination can improve the overall permeability of the porous separation article.

### Adsorbents, Fillers, and Filter Aids

Adsorbents useful in embodiments of the present disclosure can be those capable of adsorbing and desorbing specific molecules. The adsorbents are particles or fibers are not merely fillers or pigments, but are those which have a physical, electrical, or chemical interaction when they come into proximity or contact with dissolved or suspended materials in a fluid (liquid or gas) composition.

In certain embodiments, adsorbents, fillers, and filter aides include, but are not limited to: activated carbon, molecular sieves, silica gel, zeolitic adsorbents, metal organic framework, activated alumina, zirconium hydroxide, phosphate Minerals, triphylite, monazite, hinsdalite, pyromorphite, vanadinite, erythrite, amblygonite, lazulite, turquoise, autunite, phosphophyllite, struvite, xenotime; phosphates of apatite and mitridatite groups, oxide minerals, periclase, zincite, hematite, rutile, spinel groups; cuprite, baddeleyite, uraninite, thoriranite, chrysoberyl, and columbite, hydroxide minerals, goethite group, brucite, manganite, romanechite, silicates, phenakite, olivine, garnet, zircon, aluminum silicate, alumino solicicate, humite, epidote, pyroxene, pyroxenoid, amphibole, serpentine, clay mineral, mica, chlorite, quartz, feldspar, feldspathoid, scapilite, zeolite groups; datolite, titanite, chloritoid, mullite, hemimorphite, lawsonite, llvaite, vesuvianite, beitoite, axinite, beryl, sugilite, corierite, tourmaline, petalite, analcime, carbonate minerals, such as calcite, aragonite, dolomite, monoclinic groups; hydromagnesite, ikaite, lansfordite, monohydrocalcite, natron, zellerite, alginic acids and alginic salts, metal organic frame (MOF) works, such as bidentate or tridentate carboxylates, azoles, and other ligand types, and double crystal molecular sieves etc., which have special affinity to adsorb specific materials. In certain embodiments, the adsorbent can be activated carbon, carbon fibers, carbon nanotubes, wood chips, ion-exchange resins, ceramics, diatomaceous earth, or molecular sieves. The interactive particles could also be enzymes, antibodies, and proteins immobilized on a support substrate.

In certain embodiments, the adsorbent can be in the size range of 0.1 to 3,000 micrometers, and preferably from about 1 micrometer to about 500 micrometers in diameter, with fibers being about 0.1 micrometer to about 250 micrometers in diameter of essentially unlimited length to width ratio. In certain embodiments, fibers are chopped to no more than 5 mm in length. In certain embodiments, the adsorbent fibers or powders can have sufficient thermal conductivity to allow heating of the fine particulate mixtures. In certain embodiments, utilizing an extrusion or compression molding process, the particles and fibers can have melting points sufficiently above the melting point of the small particle size binder resin to prevent both substances from melting and producing a continuous melted phase rather than the usually desired multi-phase system.

In certain embodiments, the adsorbent can be activated carbon. In certain embodiments, an activated carbon having a large level of surface area is useful, as are nano carbon fibers, to increase or maximize the surface area of the absorbent.

There are many sources of activated carbon and various techniques to differentiate the performance of each activated carbon per application. Sources of activated carbon include, but are not limited to, coconut shell, bitumen, coal, grass, organic polymers, hard wood, and soft wood. Porosity can be characterized by the N₂ BET surface area curves. A high N₂ BET surface area per mass volume may be useful, but not always practical for manufacturing. A property related to manufacturing with solid state extrusion or compression molding methods can be the apparent density, as measured by ASTM D2854, for material conveying and the hardness, as measured by ASTM D3802, when densifying.

A hard carbon can be useful to economically manufacture densified block with known state of the art manufacturing. In certain embodiments, a soft carbon with high BET surface area is useful.

Hard carbons are considered those with a ball pan hardness per ASTM D 3802 to be greater than 80% and soft carbons are considered when measured by the same method as being less than or equal to 80%. Low N₂ BET surface area is considered less than 1400 m²/g. while high N₂ BET surface area is considered greater than or equal to 1400 m²/g.

### Process for Preparing an Immobilized Media Binder

The present disclosure provides a process for preparing an immobilized media binder.

The inventors have surprisingly discovered that when preparing an immobilized media device according to embodiments of the present disclosure a bimodal particle size binder can have the benefits of a lower cost, reduced overall binder level, equivalent or greater strength, and improved small particle retention.

A bimodal binder generally is a bimodal binder that has a small particle size binder and a large particle size binder.

The small size particle binder, large size particle binder, or absorbent particles can be blended and processed by several methods. The binder particles can be in a powder form, which can be dry blended with the sorbent materials. Solvent or aqueous blends may also be formed by known means.

There are generally three methods to form a solid porous absorbent article from a homogeneous mixture of the adsorbent and binder: 1) dry powder homogeneous blends which are compression molded, 2) dry powder homogeneous blends which are extruded—a suitable extrusion process is disclosed in WO 2014055473, which is incorporated by reference herein; and 3) a polymer dispersion containing enough solvent to soften, but not dissolve the polymer binder. The solvent is removed during or after the formation of the solid porous absorbent article

Because a very dense solid absorbent article can be useful, compression molding and extrusion processing at higher pressures can be used. The compression molding and extrusion processes can be practiced in a manner that causes a softening of the polymer binder particles, but does not cause them to melt and flow to the point that they contact other polymer particles and form agglomerates or a continuous layer (e.g., does not cause them to flow to the extent that they form a continuous or semi continuous layer that coats the functional media surface). To be effective in the contemplated end-uses, the polymer binder remains as discreet polymer particles that bind the adsorbent materials into an interconnected web, for good permeability.

The most economical solution for high quality and high output capacity can be utilizing the extrusion process which makes uniform and highly packed immobilized porous media.

An advantage of the extrusion can be that the absorbent density can be fairly constant across the article, while a compression molded article tends to show a density gradient. It can be difficult to have a uniform packing density gradient on a compression molded article especially as the aspect ratio (length/diameter ratio) increases. An advantage of a compression molded process is that a large variety of shapes are available.

The polymer binder particles/adsorbent mixture or blend can be formed into a porous block article in an extrusion process, such as that described in U.S. Pat. No. 5,331,037. The polymer binder/adsorbent material composite of the present disclosure can be dry-blended, optionally with other additives, such as processing aids, and extruded, molded or formed into articles.

A typical process for forming the immobilized media device involves combining or mixing small particle size binder, large particle size binder, one or more adsorbents. The adsorbents have melting or softening points significantly higher than those of the binder particles. To this mixture can be added a variety of additives and processing aids. “Additives” are defined as materials that produce desirable changes in the properties of the final product, such as plasticizers that produce a more elastic or rubbery consistency, or stiffeners that produce a strong, brittle, and more ceramic-like final product. “Processing aids” are defined as materials that allow the mixture to be processed with greater ease, such as lubricants for injection molding. The binder should constitute about 3 to about 30% by weight of the overall mixture and, preferably, about 4 to about 8%.

The mixing process typically used to mix binder and adsorbents is designed to produce as uniform a final product as possible. The quality of the mixture produced by the mixing equipment is important in the process. Generally powder mixtures (those not containing significant quantities of long fibers) can be effectively mixed using a modified ball mill or plow mixer, while mixtures of fibers and particles can be effectively dispersed in a high-intensity mincing mixer.

The resulting mixture, is then processed by a procedure which may include any of a number of conventional processes often applied to plastics. These include extruding to produce objects with two dimensional uniform shapes, hot roll compacting to produce thin sheets or thick slabs of material, or compression or injection molding to produce complex bulk shapes.

To accomplish the formation of the unique continuous web of the binder resin and the immobilization or forced point-bonding of the adsorbents, the equipment is operated in such a manner as to obtain a critical combination of applied pressure, temperature, and shear in a required time sequence. The conditions required to convert the binder particles from their original, normally powder or spherical particulate form, into a thin, continuous web matrix within the final structure varies according to the type of resin used. However, the basic requirements include the following steps.

1. In the absence of any significant pressure or shear, the mixture is first brought to a temperature sufficiently above (preferably at least about 20° C., most preferably about 40° C. above) the softening point of the binder resin but normally below the softening point of the interactive particles and fibers within the mixture.

2. After being heated to at least the temperature of step 1, the mixture is placed under sufficient applied pressure, generally at least about 50 psi (3.5 kg/cm), preferably at least about 1000 psi (70.31 kg/cm) and most preferably at least about 6,000 psi (421.86 kg/cm) to substantially immediately consolidate the loose material and work the binder resin by the surrounding interactive particles to convert at least a portion of said binder material particles into a continuous web between the interactive particles. The applied pressure must be sufficient to “activate” the binder and is applied only upon reaching the necessary temperature as mentioned in step 1.

3. The mixture must undergo at least some minimal (finite) shear during the application of pressure, even if the shear is simply the movement of the particles required to consolidate the mass from its originally loose form into a more compact form. During extrusion, although the particles would be pre-consolidated during heating in the die, the material experiences a combination of shear and pressure in the final forming portion of the die where temperature, pressure drop, and shear are sufficient to accomplish the conversion of the binder.

4. The application of heat and pressure must be of sufficiently short duration that the continuous web formed during the process does not revert to a non-continuous condition as a result of melting and reconsolidation into individual droplets or particles.

5. The process is conducted at great speed and then the resulting immobilized material is relatively quickly cooled to a temperature below the melting point of the binder to “freeze” the unstable structure once it is formed.

It has been found that a minimum applied pressure and significant shear are required to “activate” the process. Below a critical pressure, no continuous binder structure is observed to occur. Forced point-bonding of the particles can, however, still occur.

Continuous extrusion under heat, pressure and shear can produce an infinite length 3-dimensional multi-phase profile structure. To form the continuous web of forced-point bonding of binder to the adsorbent materials, a combination of applied pressure, temperature, and shear is used. The composite blend is brought to a temperature above the softening temperature, but below the melting point, significant pressure applied to consolidate the materials, and enough shear to spread the binder and form a continuous web.

The extrusion process can produce a continuous block structure at any diameter and length desired. Lengths of 1 cm to hundreds of meters are possible with the right manufacturing equipment. The continuous solid block can then be cut into desired final lengths. Typical diameters of the solid blocks would be 15 cm or less, and more preferably 15 cm or less—though with the proper size die(s) larger diameter structures up to 1.5 meters and larger could be produced.

An alternative to a single, solid structure, is forming two or more structures—a solid rod, and one or more hollow block cylinders designed to nest together to form the larger structure. Once each annular or rod-shaped block component is formed, the components can be nested together to create a larger structure. This process can provide several advantages over the extrusion of a single large structure. The blocks with smaller cross-sectional diameter can be produced at a faster rate than producing a large, solid, single-pass block. The cooling profile can be better controlled for each of the smaller-cross sectional pieces. A further advantage of this concept may be reduced gas diffusion path lengths through the monoliths as the spacing between concentric blocks could serve as channels for rapid flow of gas.

### Method for the Separation of Components of a Fluid

Embodiments of the present disclosure provide a method for the separation of components of a fluid or for the storage or transport of a fluid.

The immobilized media binders of the present disclosure can be used to form separation articles, including block articles, which are useful from removing anionic, cationic, and oxy ion contaminates, from a fluid stream. Removal of heavy metals can be achieved by use of separation articles made in accordance with the present disclosure.

The immobilized media devices of the present disclosure differ from membranes. A membrane works by rejection filtration—having a specified pore size, and preventing the passage of particles larger than the pore size through the membrane. The immobilized media binders of the present disclosure instead rely on adsorption or absorption of by interactive particles to remove materials from a fluid passing through the separation device, however due to the solid structure it can also act as a particulate filter by rejecting particles or trapping particles within the formed structure.

The immobilized media devices of the present disclosure, having interconnectivity of interactive particles, can be formed by means known in the art for forming solid articles. Useful processes for forming the separation articles of the invention include, but are not limited to: an extrusion process, as taught in U.S. Pat. No. 5,019,311, compression molding, and an (aqueous) dispersion binding process.

The immobilized media devices can be used to purify and remove unwanted materials from the fluid passing through the separation article, resulting in a more pure fluid to be used in various commercial or consumer applications. The immobilized media binders can also be used to capture and concentrate materials from a fluid stream, these captured materials then removed from the separation article for further use. The immobilized media binders can be used for potable water purification (hot and cold water), and also for industrial uses. By industrial uses is meant uses at high temperatures (greater than 50° C., greater than 75° C., greater than 100° C. greater than 125° C. and even greater than 150° C., up to the softening point of the polymer binder; uses with organic solvents, and in pharmaceutical and biological clean and pure uses.

Immobilized media devices of the present disclosure can be any size or any shape. In one embodiment, the article can be a hollow tube formed by a continuous extrusion of any length. Water or other fluid flows under pressure through the outside of the tube, and can be filtered from the outside to inside of the tube, and is collected after passing through the filter.

Immobilized media devices formed in accordance with the present disclosure are useful for the removal of inorganic and ionic species from aqueous, non-aqueous, and gaseous suspensions or solutions, including but not limited to cations of hydrogen, aluminum, calcium, lithium, sodium, and potassium; anions of nitrate, cyanide and chlorine; metals, including but not limited to chromium, zinc, lead, mercury, copper, silver, gold, platinum, iron and other precious or heavy metal and metal ions; salts, including but not limited to sodium chloride, potassium chloride, sodium sulfate; and removal of organic compounds from aqueous solutions and suspensions.

In one embodiment, an immobilized media devices of the present disclosure can be used to remove mercury vapor from a gaseous stream. In another embodiment, an immobilized media binder of the present disclosure can be used to remove heavy metals.

### EXAMPLES

The immobilized media devices, methods, and processes described herein are now further detailed with reference to the following examples. These examples are provided for the purpose of illustration only and the embodiments described herein should in no way be construed as being limited to these examples. Rather, the embodiments should be construed to encompass any and all variations which become evident as a result of the teaching provided herein.

Materials used in the examples:

| | Average Particle size |
|---|---|
| Binder Material Used in Examples | (micometers) Mv |
| Kyblock ® FG 42 PVDF Binder | 12.38 |
| Kyblock ® FG 81 PVDF Binder | 9.00 |
| Orgasol ® 2001 EXD Nat 1 Polyamide Binder | 10 |
| Plexiglas 30D54 PMMA Binder | 15 |
| UHMWPE GUR 2122 | 142.70 |
| LDPE FN 510 | 22.94 |

The particle size was measured using light scattering. In these experiments a Microtrac S3500 laser diffraction analyser was used. This instrument uses the phenomenon of scattered light from multiple laser beams projected through a stream of particles. The amount and direction of light scattered by the particles is measured by an optical detector array, and then analyzed by the Microtrac software. The average particle size reported are volume based (Mv). Mv—Mean diameter in microns of the “volume distribution” represents the center of gravity of the distribution.

The procedure used to measure the particle size is as follows: Add 2 ml of triton X 100 (10% solution in water) into a 100 ml glass beaker. Add 0.5 gm binder material in powder form directly into the beaker and mix. Dilute the mix using 60 ml DI water. Ultrasonicate the mix for 50% duty cycle, 8 output for 30 sec. keeping the tip of sonicator half way into the sample. The sample jar is kept on magnetic field for constant stirring. Run sample using the Microtrac 53500 light scattering instrument.

### Example 1: Preparation and Testing of Filtration Blocks

Filtration blocks were prepared via compression molding with an outside diameter of 2.5 inches, an inside diameter of 1.25 inches, and an approximate length of 5 inches. Blocks were compression molded from component blends in pre heated molds in a 230° C. oven for 30 minutes. The component blends were prepared with Jacobi Aquasorb CX activated carbon, between 20 and 30 weight percent Celanese GUR 2122 cryogenically ground UHMWPE and 0-5 weight percent Kyblock® FG-42 based on total weight of the block components (i.e. binder plus adsorbent(s)). In the examples where both binders were used, the Kyblock binder was mixed thoroughly with activated carbon before the addition of the UHMWPE.

The retention of small particles was measured by filtering deionized water outside in at a tap pressure of about 4 bar. Water was collected 1 liter at a time for the first 10 liters of filtration. The filtered water was collected and the transmission through a 0.5 liter glass jar was measured. The transmission value of a jar containing deionized water was 0.85. Light transmission was selected over turbidity or other methods to quantify retention of particles because activated carbon has a tendency to adsorb rather than scatter light.

Block strength was measured on an lnstron 4201 universal test frame using a 3 point bend fixture with a span of 5 inches and a crosshead speed of 0.05 inches per minute. As shown in Table 1, the addition of Kyblock® binder improved strength and small particle retention as quantified by improved light transmission of filtered water. Sample 5 shows nearly equivalent strength and superior small particle retention to Sample 1 with a lower binder content.

TABLE 1
Block Strength and Light Transmission

| | | | Jacobi | | | | |
|---|---|---|---|---|---|---|---|
| | | | Aquasorb CX | | | | |
| | | | Activated | | | | |
| | GUR 2122 | Kyblock ® | Carbon | | | | |
| | UHMWPE | FG-42 | 80 × 325 mesh | | Break | Light | Light |
| | Weight | Weight | Weight | Density | Strength | Transmission | Transmission |
| Sample | fraction | fraction | fraction | (gm/cc) | (N) | 2 Liters | 4 Liters |
| Control | 0.3 | 0 | 0.7 | 0.634 | 2310 | 0.36 | 0.58 |
| 1 | | | | | | | |
| 2 | 0.3 | 0.01 | 0.69 | 0.656 | 2649 | 0.52 | 0.68 |
| 3 | 0.3 | 0.03 | 0.67 | 0.708 | 2958 | 0.70 | 0.81 |
| 4 | 0.3 | 0.05 | 0.65 | 0.719 | 4053 | 0.82 | 0.85 |
| 5 | 0.25 | 0.03 | 0.72 | 0.657 | 2088 | 0.80 | 0.81 |
| Control | 0.2 | 0 | 0.8 | 0.675 | 1510 | 0.10 | 0.35 |
| 6 | | | | | | | |
| 7 | 0.2 | 0.03 | 0.77 | 0.662 | 1088 | 0.75 | 0.81 |
| 8 | 0.2 | 0.05 | 0.75 | 0.671 | 1418 | 0.82 | 0.83 |

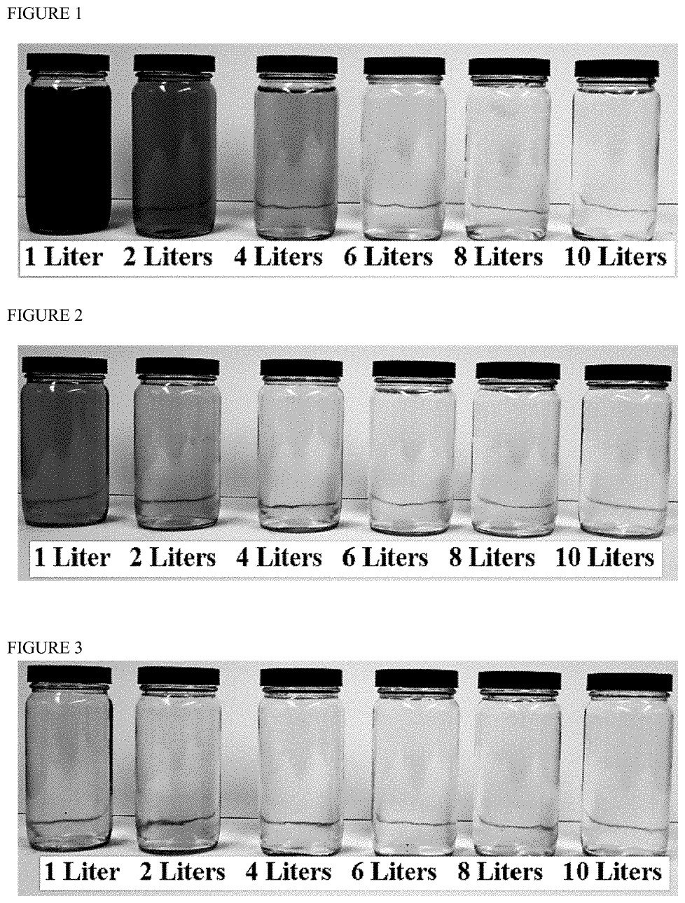

FIG. 1 shows the result of filtration using the control sample 1. The water passed through the block carrying the small particles of adsorbent out of the block resulting in highly turbid water as can be seen by the darkness of the filtered fluid. Even at 10 liters the water still shows turbidity.

FIG. 2 shows the results of filtration for Sample 3 having 3 wt % small particle size binder. As can be seem the filtered fluid is considerably less turbid than the control. This shows that the small particle size binder helps to retain the small particles of adsorbent in the block.

FIG. 3 shows the results of filtration for Sample 4 having 5 wt % small particle size binder. As can be seem the filtered fluid is considerably less turbid than the control and also less turbid that Example 3 at equivalent filtration volumes. This shows that the small particle size binder helps to retain the small particles of adsorbent in the block and increasing the binder from 3% to 5% increase the retention of the adsorbent in the block.

### Example 2: Preparation and Testing of Filtration Blocks

Filtration blocks were prepared via compression molding with an outside diameter of 2.5 inches, an inside diameter of 1.25 inches, and an approximate length of 5 inches. Blocks were compression molded from component blends in pre heated molds in a 230° C. oven for 30 minutes. The component blends were prepared with Jacobi Aquasorb CX activated carbon, between 9 and 12 weight percent Microthene FN 510 LDPE, 16% SZT lead surrogate and 0 and 3 weight percent Kyblock® FG 42 PVDF binder. In the examples where both binders were used, the Kyblock® FG 42 binder was mixed thoroughly with activated carbon before the addition of the FN 510 LDPE. In case with FN 510 LDPE the binder was pretreated with 0.1% fume silica.

The retention of small particles was measured by filtering deionized water outside in at a tap pressure of about 4 bar. Water was collected 1 liter at a time for the first 10 liters of filtration. The filtered water was collected and the transmission through a 0.5 liter glass jar was measured. The transmission value of a jar containing deionized water was 0.85. Light transmission was selected over turbidity or other methods to quantify retention of particles because activated carbon has a tendency to adsorb rather than scatter light.

The FN 510 LDPE binder hold the carbon fine well, but it fails to hold smaller particle size lead surrogate. Hence results in white water. As shown in Table 3, the addition of Kyblock® FG 42 binder improved smaller lead surrogate retention as quantified by improved light transmission of filtered water. The pure Kyblock® FG 42 binder performed as well.

TABLE 2
Light Transmission

| | | | | Jacobi | | | |
|---|---|---|---|---|---|---|---|
| | | | | Aquasorb CX | | | |
| | | | | Activated | | | |
| | | Kyblock ® | FN 510 | Carbon | | | |
| | | FG-42 | LDPE | 80 × 325 mesh | | Light | Light |
| | Lead | Weight | Weight | Weight | Density | Transmission | Transmission |
| Sample | Surrogate | fraction | fraction | fraction | (gm/cc) | 2 Liters | 4 Liters |
| 10 | 0.16 | 0 | 0.12 | 0.72 | 0.64 | 0.37 | 0.61 |
| 11 | 0.16 | 0.03 | 0.09 | 0.72 | 0.67 | 0.79 | 0.84 |
| 12 | 0.16 | 0.12 | 0 | 0.72 | 0.66 | 0.76 | 0.81 |

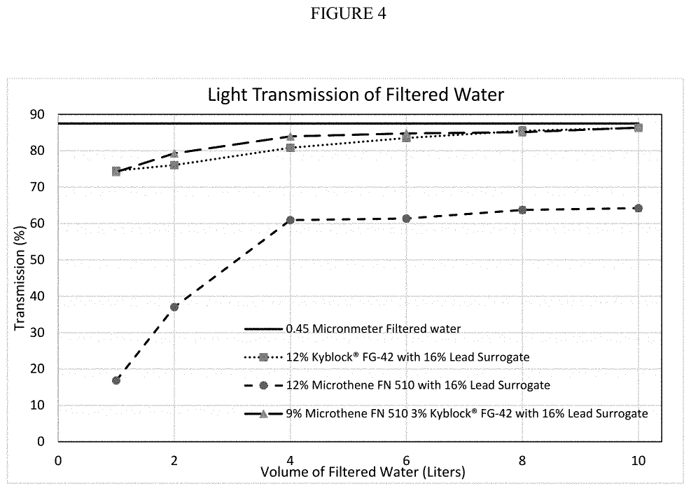

FIG. 4 shows the absorbance of the filtrate versus the volume of water filtered of Example 2, samples 10, 11 and 12. As can be seem in the graph, the use of the small particle size binder results in greatly improved light transmission (i.e. retention of the absorbance in the block) as compared to having just the large size binder

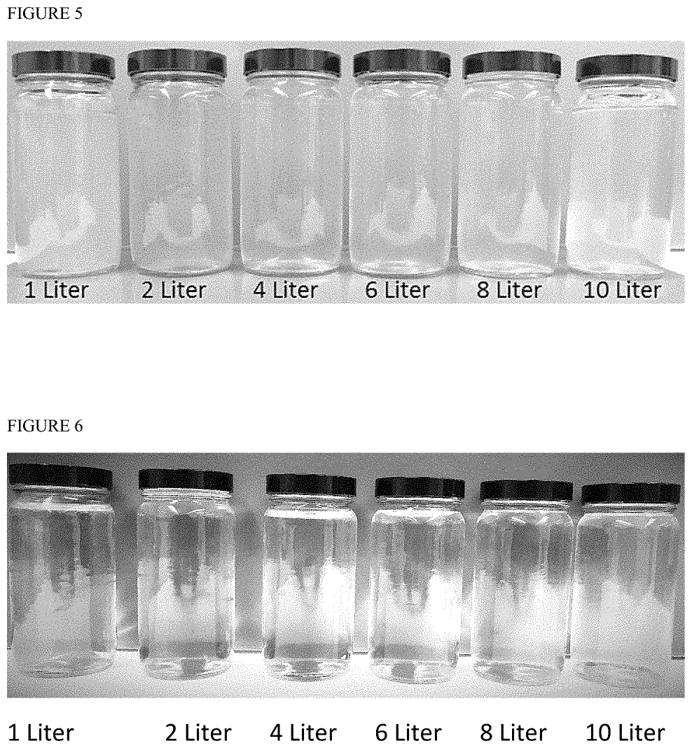

FIG. 5 shows the results of filtration for Sample 10. As can be seem the filtered fluid at 1 and 2 liters is turbid. This shows that the small particle of adsorbent are not being well retained in the block.

FIG. 6 shows the results of filtration for Sample 11 having 3 wt % small particle size binder. As can be seem the filtered fluid is not turbid. In FIG. 6, the water is clear with 9% FN 510 and 3% FG 42 compared to 12% FN 510 block (FIG. 5) confirmed using transmission.

This shows that the small particle size binder helps to retain the small particles of adsorbent in the block.

### Example 3: Preparation and Testing of Filtration Blocks

Filtration blocks were prepared via compression molding with an outside diameter of 2.5 inches, an inside diameter of 1.25 inches, and an approximate length of 5 inches. Blocks were compression molded from components blends in pre heated molds in a 260° C. oven for 30 minutes. The components blends were prepared with Jacobi Aquasorb CX activated carbon, 20 weight percent Celanese GUR 2122 cryogenically ground UHMWPE and 5 weight percent of either Plexiglas 30D54 PMMA Binder, or Orgasol® 2001 EXD Nat 1 Polyamide Binder.

The blocks had a density comparable to the Control Block 6 from Example 1. Just like with the use of Kyblock binder, the incorporation of PMMA or polyamide small binder significantly improved the ability of the block to retain small adsorbent particles during water filtration experiments.

1. An immobilized media device, comprising:
a. at least one adsorbent;
b. from about 0.5 to about 15 weight percent a small particle size binder; and
c. from about 8 to about 50 weight percent a large particle size binder based on total weight of the device.

2. The device according to claim 1, wherein the device is formed into a monolith, an annulus or a solid article.

3. The device according to claim 1, wherein said small particle size binder and large particle size binder are immiscible.

4. The device according to claim 1, wherein the small particle size binder and large particle size binder are miscible or are the same type of polymer.

5. The device according to claim 1, where said small particle size binder and large particle size binder comprise different monomer repeat units.

6. The device according to claim 1, wherein the adsorbent comprises activated carbon or molecular sieves.

7. The device according to claim 1, wherein the small particle size binder comprises a thermoplastic polymer.

8. The device according to claim 1, wherein the large particle size binder comprises a thermoplastic polymer.

9. The device according to claim 7, wherein the thermoplastic polymer of either the small particle size binder or the large particle size binder or both is selected from the group consisting of a fluoropolymer, polyethylene, polypropylene, ethyl-vinyl acetate, polyamide, polyvinylidene fluoride, polyether ether ketone, polyalkyl (meth)acrylate and polyetherketoneketone.

10. The device according to claim 8, wherein the thermoplastic polymer comprises a polyolefin.

11. The device according to claim 10, wherein the polyolefin comprises a polyalkylene.

12. The device according to claim 11, wherein the polyalkylene comprises a polyethylene.

13. The device according to claim 1, wherein the small particle size binder and the large particle size binder form a bimodal particle size system.

14. The device according to claim 1, wherein the small particle size binder has an average particle size My of about 0.01 micrometers to less than 20 micrometers.

15. (canceled)

16. The device according to claim 1, wherein the large particle size binder has an average particle size of greater than 20 micrometers to about 500 micrometers.

17. A process for preparing an immobilized media device comprising:
a. blending adsorbent and a small particle size binder; and
b. adding a large particle size binder.

18. The process according to claim 17, wherein the adsorbent is activated carbon or a small particle size adsorbent additive.

19. A method for the separation or storage of components of a fluid comprising filtering the fluid through an immobilized media device according to claim 1.

20. (canceled)

21. (canceled)

22. (canceled)

23. The method according to claim 19, wherein the fluid is selected from the group consisting of water, brine, oil, diesel fuel, biodiesel fuel, a pharmaceutical or bio-pharmaceutical fluid, aliphatic solvents, strong acids, hot (>80° C.) chemical compounds, hydrocarbons, hydrofluoric acid, ethanol, methanol, ketones, amines, strong bases, “fuming” acids, strong oxidants, aromatics, ethers, ketones, glycols, halogens, esters, aldehydes, and amines, compounds of benzene, compounds of chlorine, compounds of bromine, toluene, butyl ether, acetone, ethylene glycol, ethylene dichloride, ethyl acetate, formaldehyde, butyl amines, exhaust gases, automotive exhaust, groundwater, methane, naptha, butane, kerosene, and other hydrocarbon chemicals.

24. The method according to claim 19, wherein the components are selected from the group consisting of particulates; biological and pharmaceutical active ingredients; organic compounds; acids, bases, hydrofluoric acid; cations of hydrogen, aluminum, calcium, lithium, sodium, and potassium; anions of nitrate, cyanide and chlorine; metals, chromium, zinc, lead, mercury, copper, silver, gold, platinum, iron a; salts, sodium chloride, potassium chloride, sodium sulfate.
